(19) United States
(12) Patent Application Publication
(10) Pub. No.: US 2011/0191336 A1
(43) Pub. Date: Aug. 4, 2011

(54) CONTEXTUAL IMAGE SEARCH

(75) Inventors: Jingdong Wang, Beijing (CN); Xian-Sheng Hua, Beijing (CN); Shipeng Li, Palo Alto, CA (US); Hao Xu, Hefei (CN)

(73) Assignee: MICROSOFT CORPORATION, Redmond, WA (US)

(21) Appl. No.: 12/696,591

(22) Filed: Jan. 29, 2010

(51) Int. Cl. G06F 17/30

(52) U.S. Cl. 707/728; 707/E17.02

(57) ABSTRACT

Techniques for image search using contextual information related to a user query are described. A user query including at least one of textual data or image data from a collection of data displayed by a computing device is received from a user. At least one other subset of data selected from the collection of data is received as contextual information that is related to and different from the user query. Data files such as image files are retrieved and ranked based on the user query to provide a pre-ranked set of data files. The pre-ranked data files are then ranked based on the contextual information to provide a re-ranked set of data files to be displayed to the user.

### BACKGROUND

With the arrival of the Internet Age, accessing information from sources around the world can be as simple as a few strokes on a keyboard and/or a few mouse clicks on a networked device. Information such as texts, images and video clips can be uploaded to a given database and downloaded from the database through the Internet. When a user desires to obtain certain information from the Internet, the user typically enters a user query via a user interface, such as an Internet browser for example, on a personal computer, laptop computer, mobile phone, or any device that is connected to the Internet. The user query is provided to a search engine that conducts search based on the user query to retrieve results from the search to be displayed to the user for further action by the user.

As the amount of image content on the Internet rises, more and more images are available on the Internet for viewing, commenting, sharing and downloading. To facilitate searching of desired images by users of the Internet, image search engines have been developed. Existing image search engines often provide a separate interface for a user to enter the user query, which typically consists of a textual input entered by the user. The textual input can be entered, for example, by the user keying in texts in a user query input box in the interface provided by the image search engine. Alternatively, the textual input can be entered by the user copying a word or phrase from a document, e.g., a web page, and pasting the copied word or phrase into the user query input box. The image search engine then uses the user query to search for and retrieve a set of images in an order that is ranked according to the extent that the text in the user query matches the texts associated with each of the retrieved images.

When the user query consists of a word or phrase copied from a document, such as the web page that the user is viewing at the time for example, it is likely that the document contains contextual information that can help refine the meaning of the user query and, more specifically, the intent of the user. Consequently, results of image search under the aforementioned approach may be limited and less than optimal. This is because only the textual input entered by the user is investigated for image search while the context surrounding the copied word or phrase is not taken into consideration by the image search engine.

### SUMMARY

Techniques for image search using contextual information related to a user query are described. One technique first ranks images retrieved from a search according to a user query that includes textual data and then ranks the images according to contextual information related to the textual data. In other techniques, the retrieved images are first ranked according to a user query that includes image data and then ranks the images according to contextual information related to the image data.

This summary is provided to introduce concepts relating to contextual image search. These techniques are further described below in the detailed description. This summary is not intended to identify essential features of the claimed subject matter, nor is it intended for use in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an exemplary architecture of contextual image search.

FIG. 2 illustrates a block diagram of an illustrative computing device that may be used to perform contextual image search.

FIG. 3 illustrates an exemplary architecture of contextual image search where the user query is a textual query.

FIG. 4 illustrates a first exemplary architecture of contextual image search where the user query is an image query.

FIG. 5 illustrates a second exemplary architecture of contextual image search where the user query is an image query.

FIG. 6 illustrates an exemplary instance of contextual information for a textual query.

FIG. 7 illustrates an exemplary instance of contextual information for an image query.

FIG. 8 illustrates a flow diagram of an exemplary process of contextual image search.

FIG. 9 illustrates a flow diagram of another exemplary process of contextual image search.

### DETAILED DESCRIPTION

### Overview

This disclosure describes techniques for image search using contextual information related to a user query. When a user views a document on a computing device, the user may select a word, phrase, image or video frame that is part of the document to submit the selected word, phrase, image or video frame as the user query to a client software application on the computing device for an image search. The client software application may automatically capture contextual information associated with the selected word, phrase, image or video frame and submit both the user query and the contextual information to a contextual image search engine. The contextual information may include one or more texts, images or video frames surrounding the selected word, phrase, image or video frame. Accordingly, the image search is not based on only the user query but also augmented by the contextual information related to the user query.

Images are retrieved from the image search based on a match between the user query and the retrieved images. The retrieved images are pre-ranked according to the similarity between the user query and at least one attribute of each of these images. Afterwards, the retrieved images are re-ranked according to the similarity between the contextual information and at least one attribute of each of these images. Finally, the retrieved images are presented to the user in the re-ranked order.

The contextual image search engine may be implemented in the form of computer programs, instructions, codes, logic or computer hardware that execute contextual image searching algorithm. Although the contextual image search engine may reside on a server that is communicatively coupled to the user's computing device, alternatively the contextual image search engine may reside on the computing device either partially or entirely. In the case that the contextual image search engine resides on the computing device, the client software application may be a part of the contextual image search engine. Moreover, in addition to searching one or more databases on the Internet or a local network, the image search may also be conducted on a local database in the computing device itself such as, for example, the local drive of a personal computer.

While aspects of described techniques relating to contextual image search can be implemented in any number of different computing systems, environments, and/or configurations, embodiments are described in context of the following exemplary system architecture(s).

### Illustrative Contextual Image Search

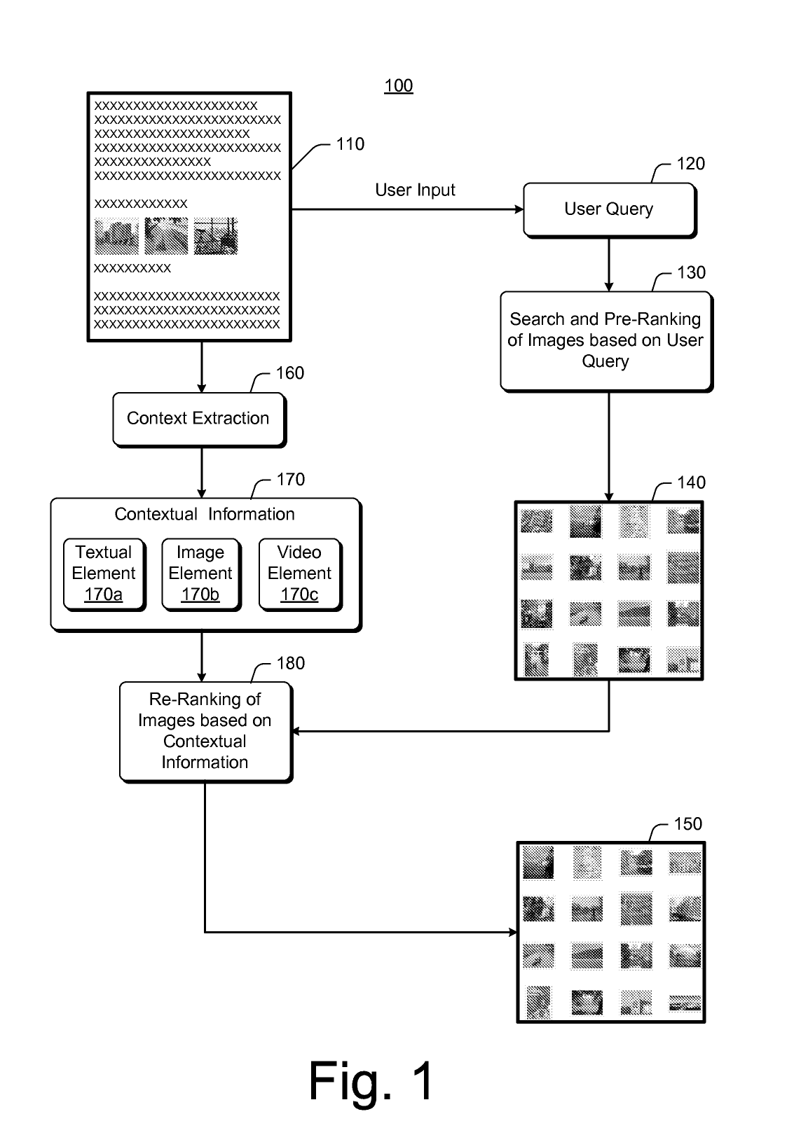

FIG. 1 is an exemplary architecture 100 of contextual image search. A document 110 displayed on a computing device contains information, or data, in the form of texts, images, video clips, or a combination thereof. In one embodiment, the document 110 is a web page viewed by the user via, for example, an Internet browser. In another embodiment, the document 110 is a document viewed by the user via, for example, a document viewing application such as the Adobe Reader® of Adobe Systems or a word processing software application.

When viewing the document 110, the user may desire to look up images related to textual data, such as a word or phrase, or image data, such as an image or a frame of a video clip, contained in the document 110. To do so, the user selects and submits at least one word, phrase, image, or video frame as the user query 120 to a contextual image search engine, which then retrieves still images or videos based on the submitted user query 120. In one embodiment, the selected textual or image data is highlighted by the user. Alternatively, other known methods of selecting textual or image data from a document may be employed. The submission of the selected textual or image data as the user query 120 to the contextual image search engine may be rendered by a client software application that resides on the computing device. In the interest of brevity, details of selecting textual or image data from the document 110 and submitting the selected textual or image data as the user query 120 to the contextual image search engine will not be described herein.

With textual or image data selected from the document 110 and identified as the user query 120, the client software application performs context extraction 160 to extract, or capture, contextual information 170 from the document 110. In general, contextual information 170 refers to additional data from the document 110 that is different from and related to the user query 120, whether the user query 120 includes textual data (denoted as q_{T}) or image data (denoted as qᵢ). Contextual information 170 of the user query 120 may contain at least one of three types of elements, namely: textual element 170a, image element 170b and video element 170c.

The textual element 170a, denoted as (t_{c}, W_{T}), is a dense representation that can be obtained by analyzing the document 110. The textual element 170a is represented in a vector space model by the vector t_{c} and the corresponding weight is denoted by W_{T}. In this model, extracted terms in the context information 170 are typically associated with weights that represent the importance of a term.

The image element 170b is obtained by analyzing the document 110, and may include one or more images and/or texts surrounding the images. The image element 170b is denoted as (I_{c}, T_{I}, w_{I}), where I_{c} and T_{I} are matrices with each column corresponding to a respective one of the images, and where w_{I} is the weight vector of each of the images. In one embodiment, features such as color moment and shape feature are extracted to represent one or more images. Each image is associated with a weight to represent its importance according to the distance between the respective image and the user query 120.

Similarly, the video element 170c is obtained by analyzing the document 110, and may include one or more videos and/or texts surrounding each of the videos. The video element 170c is denoted as (V_{c}, T_{V}, W_{V}), where V_{c} and T_{V} are matrices with each column corresponding to a respective one of the videos, and where w_{V} is the weight vector of each of the videos. In one embodiment, visual features of certain key frames of each video are extracted.

In the event that the user query 120 consists of textual data, the textual element 170a of contextual information 170 is captured as described below. Textual data occurring spatially around the textual data contained in the user query 120 and the title of the document 110 are extracted as the textual element 170a, which is represented as a vector. The associated weights are set according to the spatial distance from the user query 120, and the title of the document 110 is assigned a smaller weight.

In the event that the user query 120 consists of a selected image or video frame, the textual element 170a of contextual information 170 is captured as described below. Textual data occurring spatially around the user query 120, the file name of the selected image contained in the user query 120 and the title of the document 110 are extracted as the textual element 170a, which is represented as a vector. In this case, the textual element 170a includes one or more suggested textual queries. The associated weights are set according to the spatial distance from the user query 120, the file name of the selected image is assigned a larger weight, and the title of the document 110 is assigned a smaller weight.

The image element 170b of contextual information 170 is captured in the same manner whether the user query 120 consists of textual data or image data. The images in the document 110 are all involved and the texts surrounding these images are also extracted. The weights are set according to the distance from the user query 120. The video element 170c of contextual information 170 is captured similarly to how the image element 170b is captured. As techniques for extracting contextual information 170 are not the focus of the present disclosure, details of context extraction 160 will not be described in the interest of brevity.

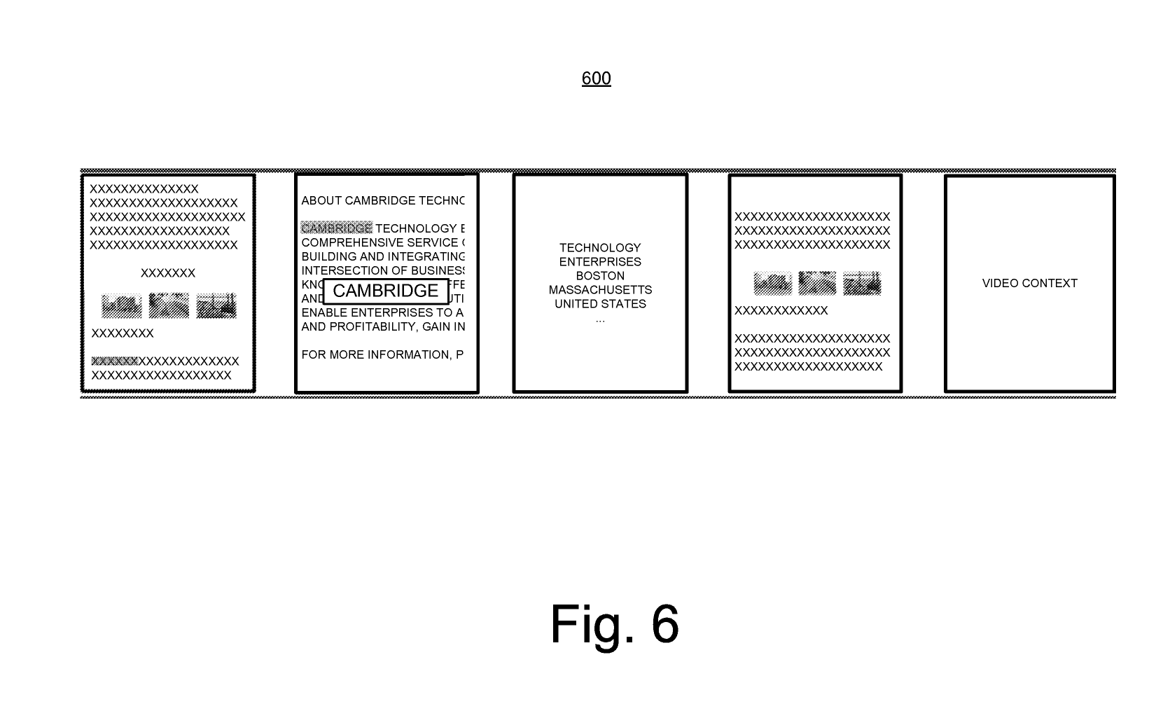

FIG. 6 illustrates an exemplary instance of the extracted contextual information 170 where the user query 120 is a textual query containing textual data. For example, the word “Cambridge” in a displayed web page is highlighted by the user viewing the web page as the selected user query for an image search. Based on the applicable context extraction algorithm, which may be run on the client software application in one embodiment or on the image search engine in another embodiment, there may be textual, image, and/or video elements in the extracted contextual information. Here, in the example shown in FIG. 6, the textual element 170a of the extracted contextual information 170 includes the words “Technology”, “Enterprises”, “Boston”, “Massachusetts”, “United States”, etc. The image element 170b includes the three images displayed in the web page as well as the texts surrounding those three images. The video element 170c, if any, may include one or more frames from one or more video clips displayed in the web page.

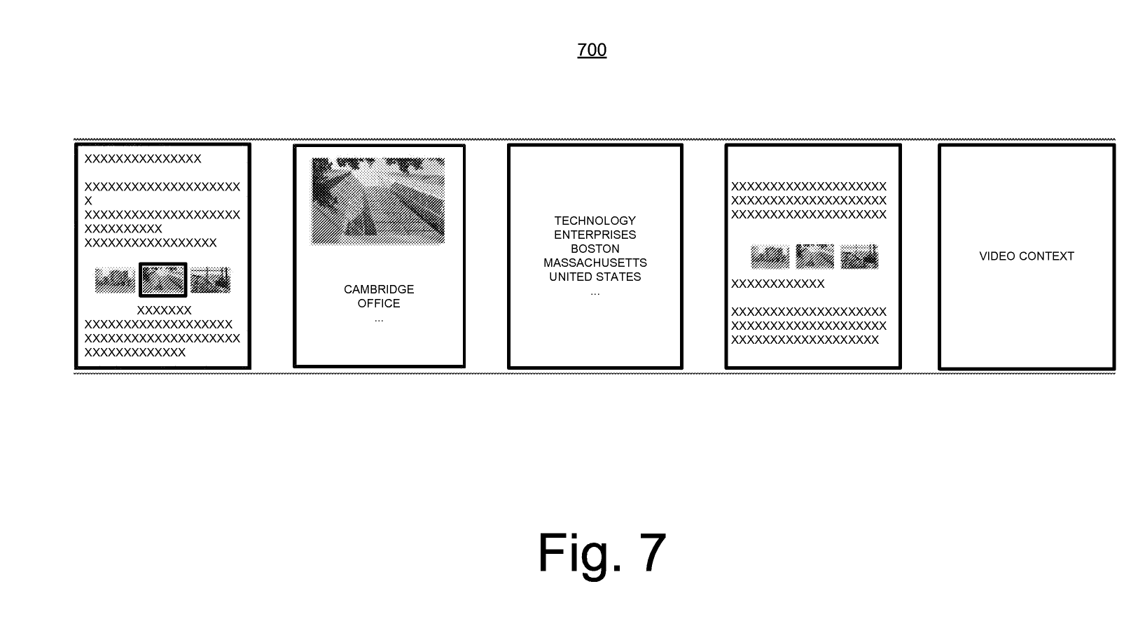

FIG. 7 illustrates an exemplary instance of the extracted contextual information 170 where the user query 120 is an image query containing image data. For example, the picture entitled “Cambridge Office” in a displayed web page is highlighted by the user viewing the web page as the selected user query for an image search. Based on the applicable context extraction algorithm, which may be run on the client software application in one embodiment or on the image search engine in another embodiment, there may be textual, image, and/or video elements in the extracted contextual information. Here, in the example shown in FIG. 7, the textual element 170a of the extracted contextual information 170 includes the words “Technology”, “Enterprises”, “Boston”, “Massachusetts”, “United States”, etc. The image element 170b includes the two images displayed in the web page other than the image highlighted as the user query, as well as the texts surrounding those two images. The video element 170c, if any, may include one or more frames from one or more video clips displayed in the web page.

Upon receiving the user query 120, the contextual image search engine performs search and pre-ranking 130 of images based on the user query 120 to retrieve and rank images that have at least one attribute matching the user query 120. During the process of image searching, the contextual image search engine examines a plurality of images or image files stored in one or more databases to retrieve images with at least one attribute that matches the user query 120. For example, when the user query 120 includes textual data, the retrieved images from the image search have associated texts, such as the respective file name for example, matching the textual data of the user query 120. The initial result of the search by the contextual image search engine is a first set of images from the plurality of images examined by the contextual image search engine. An image file refers to a file that contains one image, and may also contain textual information describing, or otherwise associated with, the image in the file.

In pre-ranking the retrieved images when the user query 120 consists of textual data, the textual data of the user query 120 is used to rank the retrieved images to provide an ordered, or pre-ranked, set of images 140, denoted as {I₁, I₂, . . . , Iₙ}, with rank values {r₁, r₂, . . . , rₙ}. Techniques for ranking the retrieved images are well known in the art and will not be described in detail in the interest of brevity.

With the pre-ranked set of images 140, the contextual image search engine performs re-ranking 180 of the pre-ranked set of images 140 based on contextual information 170 to provide a re-ranked set of images 150. The re-ranked set of images 150 is displayed on the computing device as search result for viewing by the user.

In re-ranking the pre-ranked set of images 140, one or more of the textual element 170a, image element 170b and video element 170c of contextual information 170 may be used. More specifically, a rank \check{r}ᵢ for each image Iᵢ is computed, where the rank \check{r}ᵢ is a combination of a rank based on the textual element 170a, a rank based on the image element 170b and a rank based on the video element 170c.

To obtain the rank based on the textual element 170a, the weighted similarity between texts in the textual element 170a and texts associated with each image of the pre-ranked set of images 140 is computed. A sparse word similarity matrix W with each entry representing the similarity between the corresponding words is thus provided. Mathematically, the rank based on the textual element 170a is expressed as follows:

$${\check{r}}_{i}^{t} = {t}_{c}^{T} Diag ( {w}_{T}^{1 / 2} ) W Diag ( {w}_{T}^{1 / 2} ) {t}_{i} ,$$

where tᵢ is the textual data associated with image Iᵢ.

To obtain the rank based on the image element 170b, the weighted aggregation of the ranks of all the images in the image element 170b is computed. The rank contribution for each image in the image element 170b consists of two components: one from the surrounding texts and the other from visual feature of the respective image. The rank contribution from the text of image Iₖ is similar to that of the rank based on the textual element 170a, and is mathematically expressed as follows:

\check{r}^{It}ₖᵢ=t^{T}_{Ik}W tᵢ,

where t_{Ik} is the textual data associated with image Iₖ in the image element 170b, and tᵢ is the textual data associated with image Iᵢ.

The rank contribution from the visual information is obtained as follows:

\check{r}^{Iv}ₖᵢ=(f^{I}ₖ−fᵢ)^{T}(f^{I}ₖ−fᵢ),

where f^{I}ₖ is the visual feature of image Iₖ in the image element 170b.

Then, the rank based on the image element 170b is expressed as follows:

$${\check{r}}_{i}^{I} = {\sum }_{k} {w}_{k} ( {\check{r}}_{ki}^{It} + {\check{r}}_{ki}^{Iv} ) .$$

The rank based on the video element 170c can be obtained similarly as for the rank based on the image element 170b. The rank contribution for each image, or frame, in the video element 170c consists of two components: one from the surrounding texts and the other from visual feature of the respective image. The rank contribution from the text can be mathematically expressed as follows:

\check{r}^{Vt}ₖᵢt^{T}_{Vk} W tᵢ,

where t_{Vk} is the textual data associated with video Vₖ in the video element 170c, and tᵢ is the textual data associated with image Iᵢ.

The rank contribution from the visual information of video Vₖ is obtained as follows:

$${\check{r}}_{ki}^{Vv} = {max}_{j} {( {f}_{k}^{Vj} - {f}_{i} )}^{T} ( {f}_{k}^{Vj} - {f}_{i} ) ,$$

where f^{Vj}ₖ is the visual feature of the j^{th} key feature of video Vₖ.

Then, the rank based on the video element 170c is expressed as follows:

$${\check{r}}_{i}^{V} = {\sum }_{k} {w}_{k} ( {\check{r}}_{ki}^{Vt} + {\check{r}}_{ki}^{Vv} ) .$$

The final rank of an image is obtained by combining the above ranks together, and is used to order the pre-ranked set of images 140 into the re-ranked set of images 150. The final rank can be mathematically expressed as follows:

\check{r}ᵢ=βrᵢ+(1−β)(\check{r}^{t}ᵢ+\check{r}^{I}ᵢ+\check{r}^{V}ᵢ).

### Illustrative Computing Device

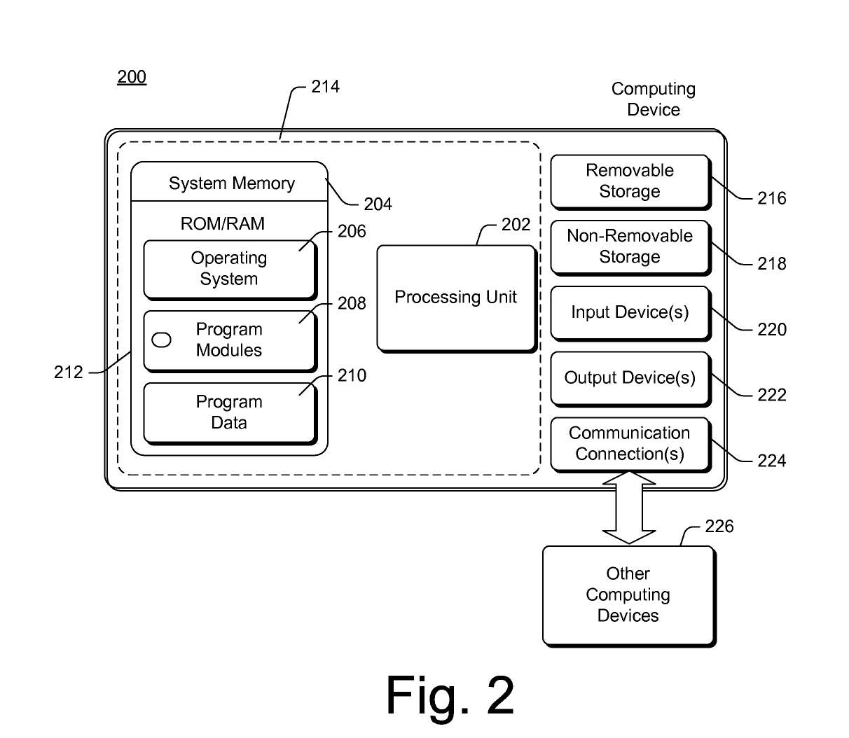

FIG. 2 illustrates a representative computing device 200 that may implement the techniques for contextual image search. However, it will be readily appreciated that the techniques disclosed herein may be implemented in other computing devices, systems, and environments. The computing device 200 shown in FIG. 2 is only one example of a computing device and is not intended to suggest any limitation as to the scope of use or functionality of the computer and network architectures.

In at least one configuration, computing device 200 typically includes at least one processing unit 202 and system memory 204. Depending on the exact configuration and type of computing device, system memory 204 may be volatile (such as random-access memory, or RAM), non-volatile (such as read-only memory, or ROM, flash memory, etc.) or some combination thereof. System memory 204 may include an operating system 206, one or more program modules 208, and may include program data 210. The computing device 200 is of a very basic configuration demarcated by a dashed line 214. Again, a terminal may have fewer components but may interact with a computing device that may have such a basic configuration.

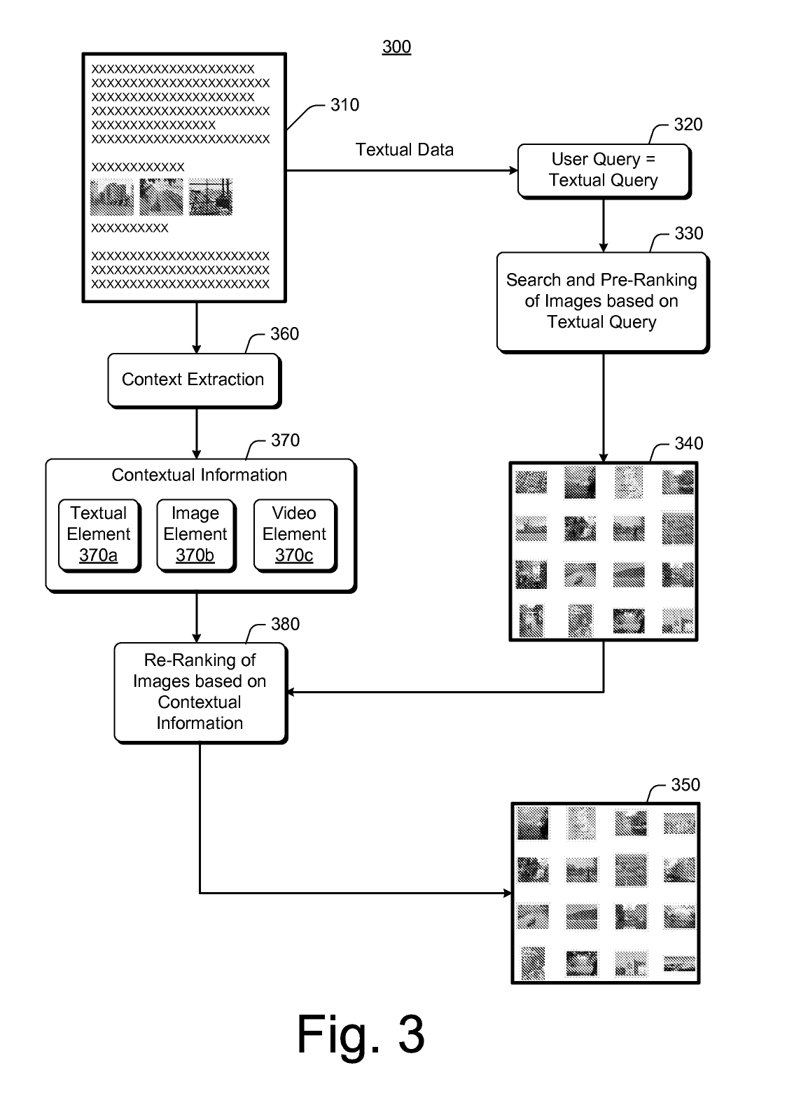

The program module 208 includes a contextual image search module 212. The contextual image search module 212 retrieves images based on a match between the user query 120 and the retrieved images. The contextual image search module 212 may carry out one or more processes as described with reference to FIG. 1 described above as well as FIGS. 3, 4, 7 and 8 described below. Alternatively, the contextual image search module 212 also includes the client software application described in the present disclosure to perform the functions of the client software application.

In one embodiment, the contextual image search module 212 pre-ranks the retrieved images to provide the pre-ranked set of images 140 according to similarity between the user query 120 and at least one attribute of each of these images. The contextual image search module 212 then re-ranks the pre-ranked set of images 140 to provide the re-ranked set of images 150 according to similarity between the contextual information 170 and at least one attribute of each image of the pre-ranked set of images 140. Finally, the re-ranked set of images 150 is presented to the user in the re-ranked order, for example, by being displayed on the output device 222 of the computing device 200 or on another computing device 226.

In another embodiment, the contextual image search module 212 receives a user query entered by a user. The user query includes textual data, such as one or more words, or image data, such as an image, and is selected from a collection of data, such as data displayed on a web page on a computing device. The contextual image search module 212 also receives another set of data from the collection of data as contextual information that is related to the user query but different from the user query. The contextual image search module 212 identifies a first subset of data files from data files stored in one or more databases, where the first subset of data files are ranked in a first order. That is, the data files of the identified first subset are ranked in an order according to similarity between information contained in the user query and at least one attribute of some or all of the data files of the data files searched. In one embodiment, the data files are image files each containing an image. For example, where the user query is an image displayed on the web page, each of the identified data files of the first subset may contain an image that has some attribute similar to the respective attribute of the image of the user query. In another embodiment, the data files are video files each containing a video clip that includes a plurality of video frames. Accordingly, each of the identified data files of the first subset may contain a video frame that has some attribute similar to the respective attribute of the image of the user query. The contextual image search module 212 then identifies a second subset of data files from the first subset, where the data files of the second subset are ranked in a second order according to similarity between the contextual information and at least one attribute of some or all of the data files of the first subset. The number of data files in the second subset may be less than or equal to the number of data files in the first subset. Thereafter, images representative of the data files of the second subset are provided to an output device 222, or another display device not part of the computing device 200, to be displayed in the second order.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by removable storage 216 and non-removable storage 218. Computer storage media may include volatile and nonvolatile, removable and non-removable media implemented in any method or technology for storage of information, such as computer readable instructions, data structures, program modules, or other data. System memory 204, removable storage 216 and non-removable storage 218 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 200. Any such computer storage media may be part of the computing device 200. Computing device 200 may also have input device(s) 220 such as keyboard, mouse, pen, voice input device, touch input device, etc. Output device(s) 222 such as a display, speakers, printer, etc. may also be included.

Computing device 200 may also contain communication connections 224 that allow the computing device 200 to communicate with other computing devices 226, such as over a network which may include one or more wired networks as well as wireless networks. Communication connections 224 are some examples of communication media. Communication media may typically be embodied by computer readable instructions, data structures, program modules, etc.

It is appreciated that the illustrated computing device 200 is only one example of a suitable device and is not intended to suggest any limitation as to the scope of use or functionality of the various embodiments described. Other well-known computing devices, systems, environments and/or configurations that may be suitable for use with the embodiments include, but are not limited to, personal computers (PCs), server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

### FIRST EXAMPLE

FIG. 3 is an exemplary architecture 300 of contextual image search where the user query is a textual query. As shown in FIG. 3, a user selects textual data, such as one or more words, from the displayed document 310 as the user query 320. Accordingly, the user query 320 is a textual query. A text-based image search 330 is performed using the user query 320 to retrieve a first subset of images 340, ranked in a pre-ranked order according to similarity between the user query 320 and texts associated with each image of the first subset of images 340.

Context extraction 360 is performed to obtain contextual information 370 from the document 310. Contextual information 370 is related to and different from the textual data contained in the user query 320, and may include a textual element 370a, an image element 370b, a video element 370c or a combination thereof. For example, the textual element 370a may include the text displayed spatially around the user query 320 and the title of the displayed document 310, the image element 570b may include other images displayed in the document 510, and the video element 570c may include one or more frames from a video clip included in the document 510. With contextual information 370, the first subset of images 340 are ranked in a re-ranked order according to similarity between contextual information 370 and at least one attribute of the images of the first subset to provide a second subset of images 350. When displayed to the user, the images of the second subset of images 350 are displayed in the re-ranked order.

In one embodiment, the actions of searching, pre-ranking and re-ranking of images as depicted in the architecture 300 are performed by a computing device like the computing device 200 of FIG. 2. In another embodiment, only pre-ranking and re-ranking of images are performed by a computing device like the computing device 200. In yet another embodiment, other than searching, pre-ranking and re-ranking of images, context extraction is also performed by a computing device like the computing device 200.

### SECOND EXAMPLE

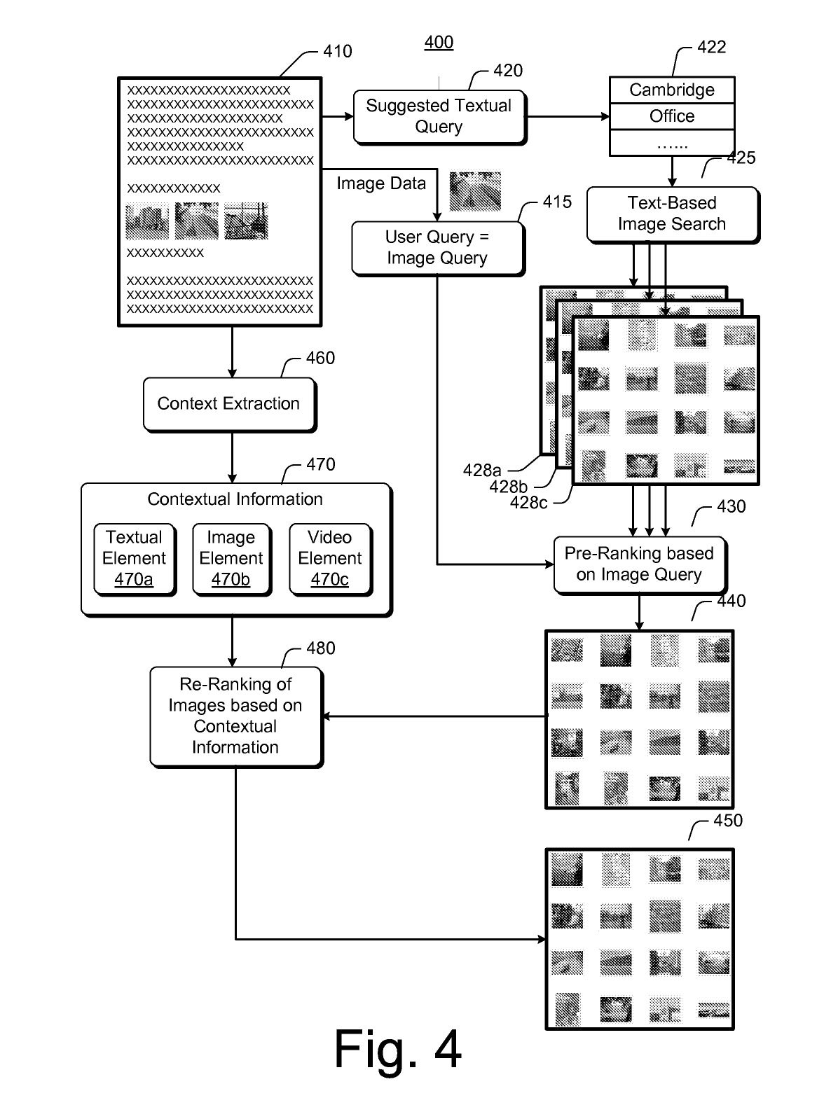

FIG. 4 is a first exemplary architecture 400 of contextual image search where the user query is an image query. As shown in FIG. 4, a user selects image data from the displayed document 410 as the user query 420. Accordingly, the user query 420 is an image query.

A suggested textual query 420 includes textual data 422 from the document 410 is used to perform a text-based image search 425. In one embodiment, the suggested textual query 420 is obtained by dividing the text surrounding the user query 420 to a number of keywords as the textual data 422. Context extraction 460, on the other hand, provides contextual information 470 that includes a textual element 470a, an image element 470b and a video element 470c. Contextual information 470 is related to and different from the image data contained in the user query 415. The textual data 422 contained in the suggested textual query 420 may be part of the textual element 470a of contextual information 470. Depending on the number of words and/or phrases in the textual data 422, in one embodiment, the text-based image search 425 yields a number of sets of images 428a-428c where each set of images corresponds to a respective one of the number of words and/or phrases in the textual data 422.

The sets of images 428a-428c are pre-ranked using the user query 415, which is an image query containing image data, to provide a first subset of images 440. The images 440 of the first subset are ranked in the pre-ranked order according to similarity between the user query 415 and at least one attribute, such as color moment or visual feature, of each image of the first subset of images 440. With contextual information 470, the first subset of images 440 are ranked in a re-ranked order according to similarity between contextual information 470 and at least one attribute of the images of the first subset to provide a second subset of images 450. When displayed to the user, the second subset of images 450 is displayed in the re-ranked order.

In one embodiment, the actions of searching, pre-ranking and re-ranking of images as depicted in the architecture 400 are performed by a computing device like the computing device 200 of FIG. 2. In another embodiment, only pre-ranking and re-ranking of images are performed by a computing device like the computing device 200. In yet another embodiment, other than searching, pre-ranking and re-ranking of images, context extraction is also performed by a computing device like the computing device 200.

### THIRD EXAMPLE

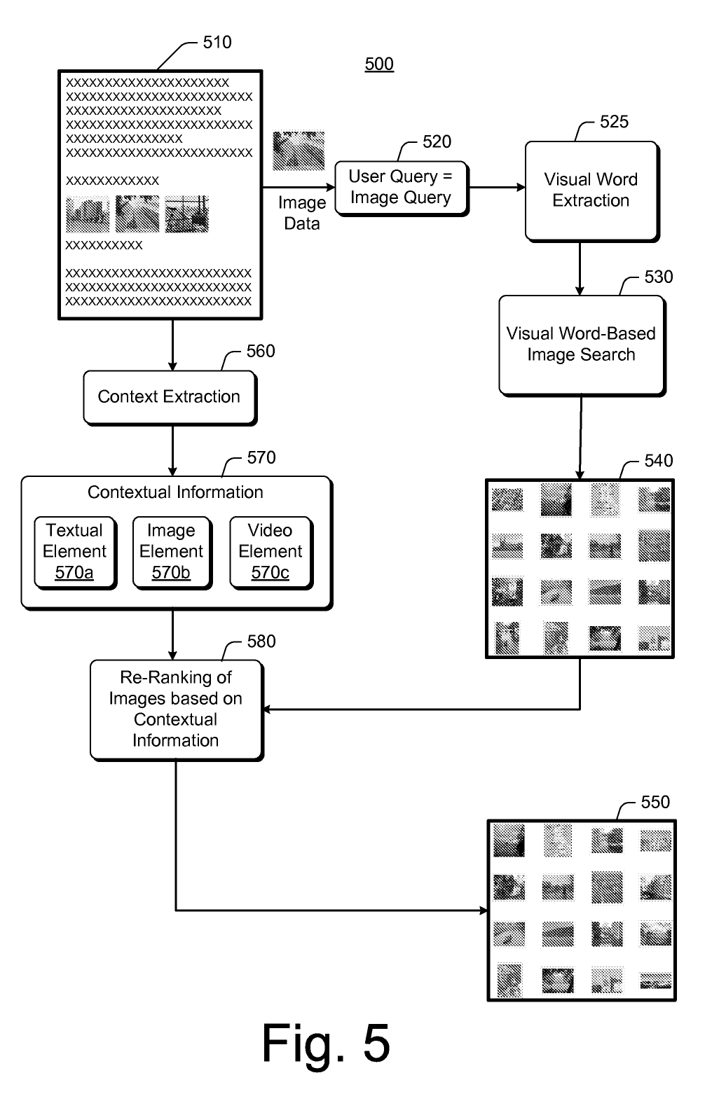

FIG. 5 is a second exemplary architecture 500 of contextual image search where the user query is an image query. As shown in FIG. 5, a user selects image data from the displayed document 510 as the user query 520. Accordingly, the user query 520 is an image query. Visual word extraction 525 is performed to extract visual words from the image data used as the user query 520. Following the visual word extraction 525, a visual word-based image search 530 is performed using the visual words extracted from visual word extraction 525 to retrieve a first subset of images 540, ranked in a pre-ranked order according to visual similarity between the visual words extracted from the query image and the visual word representation of each image of the first subset 540.

Context extraction 560 is performed to obtain contextual information 570 from the document 510. Contextual information 570 is related to and different from the image data contained in the user query 520, and may include a textual element 570a, an image element 570b, a video element 570c or a combination thereof. For example, the textual element 570a may include the text displayed spatially around the user query 520 and the title of the displayed document 510, the image element 570b may include other images displayed in the document 510, and the video element 570c may include one or more frames from a video clip included in the document 510. With contextual information 570, the first subset of images 540 are ranked in a re-ranked order according to similarity between contextual information 570 and at least one attribute of the images of the first subset to provide a second subset of images 550. When displayed to the user, the images of the second subset 550 are displayed in the re-ranked order.

In one embodiment, the actions of searching, pre-ranking and re-ranking of images as depicted in the architecture 500 are performed by a computing device like the computing device 200 of FIG. 2. In another embodiment, only pre-ranking and re-ranking of images are performed by a computing device like the computing device 200. In yet another embodiment, other than searching, pre-ranking and re-ranking of images, context extraction is also performed by a computing device like the computing device 200.

### Illustrative Operations

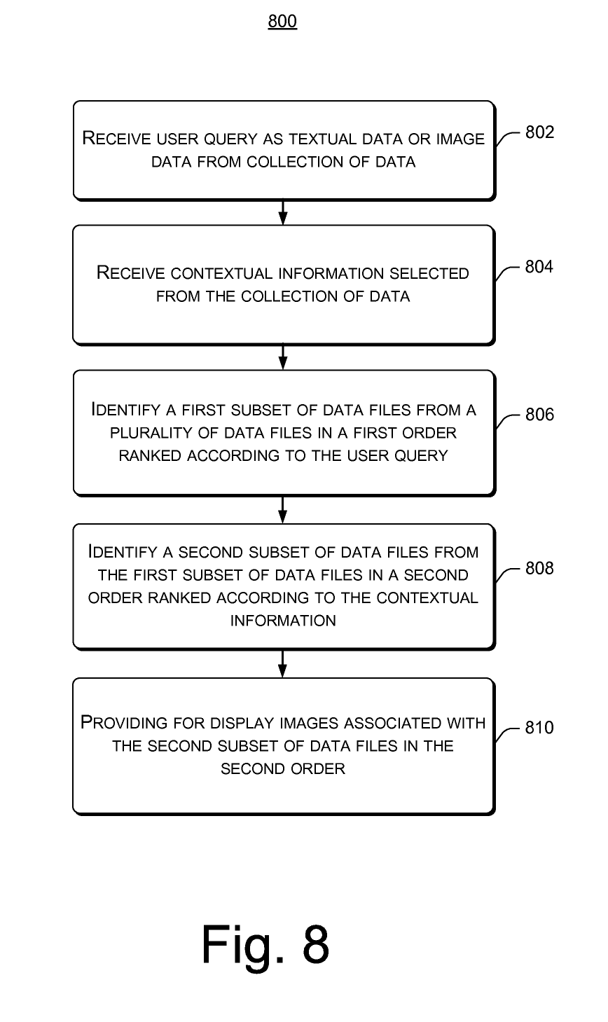

FIG. 8 is a flow diagram of an exemplary process 800 of contextual image search. At 802, a user query is received. The user query includes textual data or image data from a collection of data displayed by a computing device. For example, with reference to FIG. 1, the user query 120 includes textual or image data selected by a user from the displayed document 110. At 804, at least one other subset of data from the collection of data is received as contextual information, related to and different from the user query, by a contextual image search engine. For instance, when the user query is an image, the contextual information may include title and annotation of the image. At 806, a first subset of data files, such as image files, are identified from a plurality of data files. As shown in FIG. 1, a number of images are retrieved from one or more databases using the user query as the search term. The data files of the first subset are ranked in a first order according to similarity between information contained in the user query and at least one attribute of individual data files of the plurality of data files. At 808, a second subset of data files are identified from the first subset of data files. The data files of the second subset are ranked in a second order according to, other than that used to rank the first subset of data, similarity between the contextual information and at least one attribute of individual data files of the first subset. For example, the images of the first subset and the images of the second subset may be the same but they are arranged in a different order as one is ranked based on the user query and the other is ranked based on both the user query and the contextual information. At 810, a number of images each of which associated with a respective data file of the second subset are provided to be displayed in the second order.

In one embodiment, when the user query includes textual data, such as one or more words, displayed by the computing device, the contextual information includes the text displayed spatially around the user query and the title of the displayed document.

In one embodiment, when the user query includes an image displayed by the computing device, the contextual information includes at least one of a color moment or a shape feature of at least one displayed image other than the user query. In an alternative embodiment, when the user query includes an image or a frame of a video displayed by the computing device, the contextual information includes at least one visual feature of at least one frame of the video displayed by the computing device.

In one embodiment, when receiving at least one other subset of data from the collection of data as contextual information that is related to and different from the user query, the process 800 identifies at least one instance of textual data displayed in a spatial vicinity of the user query, a title of a document that contains data identified as the user query, or a combination thereof as the contextual information when the user query includes an instance of textual data displayed by the computing device. For example, the contextual information may be represented as a vector, each of the identified at least one instance of textual data may be assigned a respective weight according to a respective distance between the user query and the respective instance of textual data, and the identified title of the document may be assigned a weight smaller than the respective weight of each of the identified at least one instance of textual data.

In one embodiment, when receiving at least one other subset of data from the collection of data as contextual information that is related to and different from the user query, the process 800 identifies at least one instance of textual data displayed in a spatial vicinity of the user query, an image file name related to the user query, a title of a document that contains data identified as the user query, at least one displayed image other than the user query, at least one instance of textual data in a spatial vicinity of the at least one displayed image other than the user query, at least one frame of a video clip, or a combination thereof as the contextual information when the user query includes an image displayed by the computing device. For example, the contextual information may be represented as a vector. Each of the identified at least one instance of textual data, each of the at least one displayed image other than the user query, each of the identified at least one instance of textual data in a spatial vicinity of the at least one displayed image other than the user query, and each of the at least one frame of the video clip may be assigned a respective weight according its respective spatial distance from the user query. The identified title of the document may be assigned a weight smaller than the respective weight of each of the identified at least one instance of textual data. In addition, the identified image file name of the user query may be assigned a weight larger than the respective weight of each instance of textual data as well as the respective weight of each of the at least one displayed image other than the user query.

In one embodiment, when identifying a first subset of data files, the process 800 ranks the first subset of data files in the first order according to similarity between textual data of the user query and textual data of individual data files of the plurality of data files that is related to an image contained in the respective data file.

In another embodiment, when identifying a first subset of data files from a plurality of data files, the data files of the first subset ranked in a first order according to similarity between information contained in the user query and at least one attribute of individual data files of the plurality of data files, the process 800 performs a number of activities. First, at least one instance of textual data related to the user query is identified when the user query includes an image. Next, a respective subset of data files are identified from the plurality of data files for each of the at least one instance of textual data related to the user query based on similarity between the respective instance of textual data related to the user query and textual data of each data file of the respective subset of data files that is related to an image contained in the respective data file. Moreover, data files are selected from each respective subset of data files that are identified for each of the at least one instance of textual data related to the user query to form the first subset of data files. The data files in the first subset of data files are arranged in the first order ranked according to similarity between the image of the user query and at least one image of each data file of the first subset of data files.

In yet another embodiment, when identifying a second subset of data files from the first subset of data files, the process 800 ranks each data file of the first subset of data files by comparing at least one of (1) one or more attributes of each data file of the first subset with a textual element of the contextual information, (2) one or more visual features of an image element and one or more text surrounding the image element of the contextual information, (3) one or more visual features of a video element of the contextual information or (4) one or more texts surrounding the video element of the contextual information.

In still another embodiment, when identifying a second subset of data files from the first subset of data files, the process 800 computes a final ranking score for the respective image of each data file of the second subset of data files. A respective first ranking score is computed according to similarity between a textual element of the contextual information and at least one instance of textual data related to the respective image associated with each data file of the second subset of data files. A respective second ranking score is also computed according to similarity between a visual feature and texts surrounding the visual feature of an image element of the contextual information and a respective visual feature of and textual data related to the respective image associated with each data file of the second subset of data files. A respective third ranking score is further computed according to similarity between a visual feature and texts surrounding the visual feature of a video element of the contextual information and a respective visual feature of and textual data related to the respective image associated with each data file of the second subset of data files. Finally, the respective first, second, and third ranking scores are combined, such as summed together for example, to provide the respective final ranking score for the respective image of each data file of the second subset of data files.

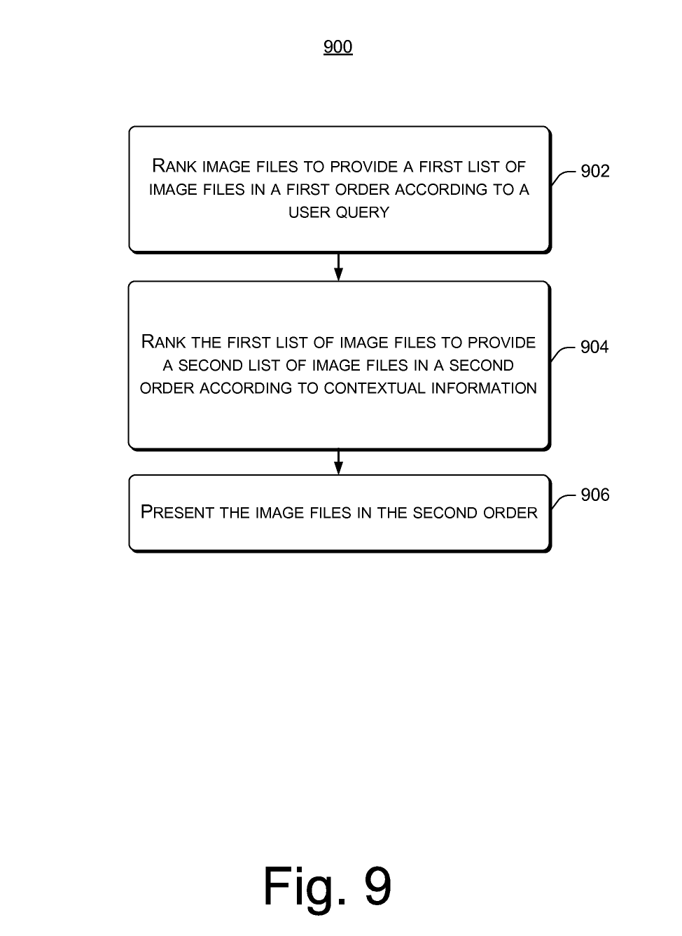

FIG. 9 is a flow diagram of an exemplary process 900 of contextual image search. At 902, a plurality of image files are ranked to provide a first list of image files in a first order according to similarity between at least one attribute of individual image files and a user query. The user query includes textual data or image data selected by a user from a collection of displayed data. For example, with reference to FIG. 4, images in the sets 428a-428c are pre-ranked to provide the first subset of images 440 based on the user query 415, which is an image query. At 904, the first list of image files are ranked to provide a second list of image files in a second order according to similarity between at least one attribute of the individual image files and contextual information that is related to and different from the textual data or image data of the user query. The contextual information includes at least one of textual data or image data from the collection of displayed data. For example, as shown in FIG. 4, the first subset of images 440 are re-ranked to provide the second subset of images 450 base on the contextual information 470, and the first subset of images 440 and the second subset of images 450 may be the same but arranged in different orders. At 906, the image files are presented to a user in the second order. For example, the image files, each containing one respective image, are provided to a display device for the images to be presented to the user in the second, or re-ranked, order.

In one embodiment, when ranking a plurality of image files to provide a first list of image files in a first order, the process 900 identifies at least one instance of textual data displayed in a spatial vicinity of the user query when the user query includes a displayed image. The plurality of image files are ranked using each of the at least one instance of textual data displayed in a spatial vicinity of the user query to provide at least one pre-ranked list of image files. Further, each of the at least one pre-ranked list of image files is ranked using the displayed image of the user query to provide the first list of image files in the first order.

In one embodiment, when ranking the first list of image files to provide a second list of image files in a second order, the process 900 computes a respective final ranking score for each image file of the first list of image files. First, a respective first ranking score is computed according to similarity between a textual element of the contextual information and at least one instance of textual data related to each image file of the first list of image files. Next, a respective second ranking score is computed according to similarity between a visual feature and texts surrounding the visual feature of an image element of the contextual information and a respective visual feature of and textual data related to each image file of the first list of image files. Furthermore, a respective third ranking score is computed according to similarity between a visual feature and texts surrounding the visual feature of a video element of the contextual information and a respective visual feature of and textual data related to each image file of the first list of image files. Finally, the respective first, second, and third ranking scores are combined to provide the respective final ranking score for each image file of the first list of image files.

In one embodiment, the process 900 receives the user query, which includes a subset of data of the collection of displayed data. The process 900 also extracts at least one other subset of data from the collection of displayed data as the contextual information.

In one embodiment, the process 900 extracts at least one instance of textual data displayed in a spatial vicinity of the user query, a title of a document containing the user query, or a combination thereof as the contextual information when the user query includes an instance of textual data from the collection of displayed data. For example, the contextual information may be represented as a vector. Each of the extracted at least one instance of textual data may be assigned a respective weight according to a respective distance between the user query and the respective instance of textual data. Further, the extracted title of the document may be assigned a weight smaller than the respective weight of each of the extracted at least one instance of textual data.

In one embodiment, the process 900 extracts at least one instance of textual data displayed in a spatial vicinity of the user query, an image file name of the user query, a title of a document containing the user query, at least one displayed image other than the user query, at least one instance of textual data in a spatial vicinity of the at least one displayed image other than the user query, at least one frame of a video clip, or a combination thereof as the contextual information when the user query includes a displayed image from the collection of displayed data. For example, the context query may be represented as a vector. Each of the identified at least one instance of textual data, each of the at least one displayed image other than the user query, each of the identified at least one instance of textual data in a spatial vicinity of the at least one displayed image other than the user query, and each of the at least one frame of the video clip may be assigned a respective weight according its respective spatial distance from the user query. The identified title of the document may be assigned a weight smaller than the respective weight of each of the identified at least one instance of textual data. Additionally, the identified image file name of the user query may be assigned a weight larger than the respective weight of each instance of textual data and the respective weight of each of the at least one displayed image other than the user query.

### CONCLUSION

The above-described techniques pertain to search of images using contextual information related to a user query. Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A method of contextual image search, the method comprising:
receiving a user query, the user query including at least one of textual data or image data from a collection of data displayed by a computing device;
receiving at least one other subset of data selected from the collection of data as contextual information that is related to and different from the user query;
identifying a first subset of data files from a plurality of data files, the data files of the first subset ranked in a first order according to similarity between information contained in the user query and at least one attribute of individual data files of the plurality of data files;
identifying a second subset of data files from the first subset of data files, the data files of the second subset ranked in a second order according to similarity between the contextual information and at least one attribute of individual data files of the first subset; and
providing for display in the second order a number of images each of which is associated with a respective data file of the second subset.

2. The method of claim 1, wherein the user query includes text displayed by the computing device, and wherein the contextual information includes at least one of a word displayed spatially around the user query, a title of a document displayed by the computing device where the text of the use query is contained, an image in the displayed document, or a video in the displayed document.

3. The method of claim 1, wherein the user query includes an image or a frame of a video displayed by the computing device, wherein when the user query includes an image the contextual information includes at least one of a color moment of at least one displayed image other than the user query, a shape feature of at least one displayed image other than the user query, displayed text data, or a displayed video, and wherein when the user query includes the frame of the video the contextual information includes at least one visual feature of at least one frame of the video displayed by the computing device.

4. The method of claim 1, wherein the receiving at least one other subset of data selected from the collection of data as contextual information that is related to and different from the user query comprises:
identifying at least one instance of textual data displayed in a spatial vicinity of the user query, a title of a document that contains data identified as the user query, an image file name if the user query includes a displayed image, or a combination thereof as part of the contextual information.

5. The method of claim 4, wherein the contextual information is represented as a vector, wherein each of the identified at least one instance of textual data is assigned a respective weight according to a respective distance between the user query and the respective instance of textual data, wherein the identified title of the document is assigned a weight smaller than the respective weight of each of the identified at least one instance of textual data, and wherein the image file name is assigned a weight larger than the respective weight of each of the identified at least one instance of textual data if the user query includes a displayed image.

6. The method of claim 1, wherein the receiving at least one other subset of data selected from the collection of data as contextual information that is related to and different from the user query comprises:
identifying at least one displayed image other than the user query, textual data associated with one or more displayed images other than the user query including respective image file names and surrounding texts, at least one frame of a displayed video, textual data associated with the displayed video including a video file name and surrounding texts, or a combination thereof as an part of the contextual information.

7. The method of claim 6, wherein the contextual information is represented as a vector, wherein each of the at least one displayed image other than the user query, each of the identified at least one instance of textual data in a spatial vicinity of the at least one displayed image other than the user query, and each of the at least one frame of the video is assigned a respective weight according its respective spatial distance from the user query.

8. The method of claim 1, wherein the identifying a first subset of data files comprises:
when the user query is textual data, ranking the first subset of data files in the first order according to similarity between textual data of the user query and textual data of individual data files of the plurality of data files that is related to an image contained in the respective data file.

9. The method of claim 1, wherein the identifying a first subset of data files from a plurality of data files, the data files of the first subset ranked in a first order according to similarity between information contained in the user query and at least one attribute of individual data files of the plurality of data files comprises:
identifying at least one instance of textual data related to the user query when the user query includes an image;
identifying a respective subset of data files from the plurality of data files for each of the at least one instance of textual data related to the user query based on similarity between the respective instance of textual data related to the user query and textual data of each data file of the respective subset of data files that is related to an image contained in the respective data file; and
selecting data files from each respective subset of data files identified for each of the at least one instance of textual data related to the user query to form the first subset of data files, the data files in the first subset of data files arranged in the first order ranked according to similarity between the image of the user query and at least one image of each data file of the first subset of data files.

10. The method of claim 1, wherein the identifying a second subset of data files from the first subset of data files comprises:
ranking each data file of the first subset of data files by comparing one or more attributes of each data file of the first subset with at least one of (1) a textual element of the contextual information, (2) one or more visual features of an image element or one or more texts surrounding the image element of the contextual information, or (3) one or more visual features of a video element or one or more texts surrounding the video element of the contextual information.

11. The method of claim 1, wherein the identifying a second subset of data files from the first subset of data files comprises:
computing a respective first ranking score according to similarity between a textual element of the contextual information and at least one instance of textual data related to the respective image associated with each data file of the second subset of data files;
computing a respective second ranking score according to similarity between a visual feature and texts surrounding the visual feature of an image element of the contextual information and a respective visual feature of and textual data related to the respective image associated with each data file of the second subset of data files;
computing a respective third ranking score according to similarity between a visual feature and texts surrounding the visual feature of a video element of the contextual information and a respective visual feature of and textual data related to the respective image associated with each data file of the second subset of data files; and
combining a ranking score associated with the first subset of data files and the respective first, second, and third ranking scores to provide a respective final ranking score for the respective image of each data file of the second subset of data files.

12. The method of claim 1, wherein each of the plurality of data files includes a respective video, and wherein the data files are ranked according to similarity between at least one attribute of one frame of the respective video in individual data files and at least one of the user query or the contextual information.

13. A method of contextual image search, the method comprising:
ranking a plurality of image files to provide a first list of image files in a first order according to similarity between at least one attribute of individual image files and a user query, the user query including at least one of textual data or image data selected by a user from a collection of displayed data;
ranking the first list of image files to provide a second list of image files in a second order according to similarity between at least one attribute of the individual image files and contextual information that is related to and different from the textual data or image data of the user query, the contextual information including at least one of textual data or image data from the collection of displayed data; and
presenting the image files to a user in the second order.

14. The method of claim 13, wherein the ranking a plurality of image files to provide a first list of image files in a first order comprises:
when the user query includes a displayed image, identifying at least one instance of textual data displayed in a spatial vicinity of the user query;
ranking the plurality of image files using each of the at least one instance of textual data displayed in a spatial vicinity of the user query to provide at least one pre-ranked list of image files; and
ranking each of the at least one pre-ranked list of image files using the displayed image of the user query to provide the first list of image files in the first order.

15. The method of claim 13, wherein the ranking the first list of image files to provide a second list of image files in a second order comprises:
computing a respective first ranking score according to similarity between a textual element of the contextual information and at least one instance of textual data related to each image file of the first list of image files;
computing a respective second ranking score according to similarity between a visual feature and texts surrounding the visual feature of an image element of the contextual information and a respective visual feature of and textual data related to each image file of the first list of image files;
computing a respective third ranking score according to similarity between a visual feature and texts surrounding the visual feature of a video element of the contextual information and a respective visual feature of and textual data related to each image file of the first list of image files; and
combining a ranking score associated with the first list of image files and the respective first, second, and third ranking scores to provide a respective final ranking score for each image file of the first list of image files.

16. The method of claim 13 further comprising:
extracting at least one instance of textual data displayed in a spatial vicinity of the user query, a title of a document containing the user query, or a combination thereof as the contextual information when the user query includes an instance of textual data from the collection of displayed data.

17. The method of claim 16, wherein the contextual information is represented as a vector, wherein each of the extracted at least one instance of textual data is assigned a respective weight according to a respective distance between the user query and the respective instance of textual data, and wherein the extracted title of the document is assigned a weight smaller than the respective weight of each of the extracted at least one instance of textual data.

18. The method of claim 13 further comprising:
extracting at least one instance of textual data displayed in a spatial vicinity of the user query, an image file name of the user query, a title of a document containing the user query, at least one displayed image other than the user query, at least one instance of textual data in a spatial vicinity of the at least one displayed image other than the user query, at least one frame of a displayed video, or a combination thereof as the contextual information when the user query includes a displayed image from the collection of displayed data.

19. The method of claim 18, wherein the context query is represented as a vector, wherein each of the identified at least one instance of textual data, each of the at least one displayed image other than the user query, each of the identified at least one instance of textual data in a spatial vicinity of the at least one displayed image other than the user query, and each of the at least one frame of the displayed video is assigned a respective weight according its respective spatial distance from the user query, wherein the identified title of the document is assigned a weight smaller than the respective weight of each of the identified at least one instance of textual data, and wherein the identified image file name of the user query is assigned a weight larger than the respective weight of each instance of textual data and the respective weight of each of the at least one displayed image other than the user query.

20. One or more computer readable media storing computer-executable instructions that, when executed, perform acts comprising:
ranking a plurality of image files to provide a first list of image files in a first order according to similarity between at least one attribute of individual image files and a user query, the user query including at least one of textual data or image data selected by a user from a collection of displayed data; and
ranking the first list of image files to provide a second list of image files in a second order according to similarity between at least one attribute of the individual image files and contextual information that is related to and different from the textual data or image data of the user query, the contextual information including at least one of textual data or image data from the collection of displayed data.
